(19) United States
(12) Patent Application Publication
(10) Pub. No.: US 2008/0236327 A1
(43) Pub. Date: Oct. 2, 2008

(54) ELECTROMECHANICAL CABLE ACTUATOR ASSEMBLY CONTROLLER

(75) Inventors: Ray COCKERHAM, Montgomery, TX (US); John SAUDER, Conroe, TX (US); Ron RABORN, Houston, TX (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: CAPRO, LTD, Willis, TX (US)

(21) Appl. No.: 12/107,365

(22) Filed: Apr. 22, 2008

Related U.S. Application Data
(62) Division of application No. 11/144,016, filed on Jun. 3, 2005.

(51) Int. Cl. F16C 1/22; F03G 1/00

(52) U.S. Cl. 74/502.6; 185/40 R

(57) ABSTRACT

An electromechanical cable actuator assembly is disclosed, the actuator having a motor, a gear assembly coupled to the motor, a spring-loaded return assembly coupled to the gear assembly being configured to apply a force to the gear assembly to return the electromechanical cable assembly to a first position; and an electronic motor control circuit coupled to the motor. The electronic motor control circuit includes a drive circuit configured to drive the motor in a first direction against the force exerted by the spring assembly and a braking circuit configured to slow the rate of return of the cable assembly to the first position.

### CROSS-REFERENCE TO RELATED APPLICATIONS

This application is a divisional of U.S. patent application Ser. No. 11/144,016, filed on Jun. 3, 2005, which claims the benefit of U.S. Patent Application No. 60/548,324, filed on Feb. 27, 2004, the specification of which is hereby incorporated by reference.

### FIELD OF THE INVENTION

The present invention pertains to a system for imparting a force on a cable; more particularly the present invention pertains to a system for imparting a force on a cable using a motor, a gear train, and a pulley. The pulley receives rotating force from the motor through the gear train and, when the pulley rotates, force is placed on the cable. The force causes the cable to move a predetermined distance.

### BACKGROUND OF THE INVENTION

Changing consumer demands for passenger vehicles in the United States have encouraged automobile manufacturers to build multiple-use or utility vehicles that are suitable to carry both passengers and/or cargo. One of the keys to the adaptability of such utility vehicles to carry either passengers and/or cargo is the invention of complex seating systems which enable individual seats to fold, to flip, to collapse—which movements enable movement into and eventual storage of the seats in recesses built into the vehicle.

Complex seating systems require complex mechanical motion control mechanisms. These complex mechanical motion control mechanisms employ latches, levers and cables to govern seat movement and placement. As demand for newer and more complex seating arrangements increases, the need has arisen to provide electromechanical actuators when latches or other mechanical locking mechanisms are to be released from a remote location, or when additional force is needed, or extended cable travel is required.

Electromechanical actuators used in vehicle seating systems are subject to a variety of design constraints. Specifically, such vehicle-mounted electromechanical actuators must be small enough to be mounted unobtrusively within a vehicle, they must place a minimal energy demand on the electrical power system of a passenger vehicle, they must be capable of rapidly handling high loads, and they must operate quietly.

While a variety of systems have been used to transform the energy of a motor into linear force on a cable; there remains a need in the art for a vehicle-mounted system that combines speed with high load capacity to quietly impart a force on a cable to effect a predetermined movement of the cable in fractions of a second while minimizing the power demand on a vehicle's electrical system.

### SUMMARY OF THE INVENTION

The disclosed vehicle-mounted electromechanical cable actuator assembly combines speed and quiet operation with a high load capacity to impart force on a cable to effect a predetermined movement of the cable in fractions of a second while minimizing the demands on a vehicle's electrical system.

The electromechanical cable actuator assembly of the present invention for exerting a force on a cable includes a motor whose electrical energy requirements are compatible with ability of a typical 12-volt electrical power system of a passenger vehicle to provide the needed electrical energy. Connected to the output shaft of the motor are a series of speed reduction and torque increasing gear sets which eventually cause a pulley to rotate. The rotation of the pulley imparts a force on a cable which is wound around the pulley.

The series of gear sets includes a face gear and spur gear set which engages a gear mounted to the output shaft of the motor. Engaging the face gear and spur gear set is an intermediate set of two spur gears. The intermediate set of two spur gears engages an arcuate or partial spur gear attached to a pulley.

The electromechanical cable actuator of the present invention also includes a spring driven backdrive collocated with the pulley. After the pulley has completed its rotation, the backdrive returns the pulley to its starting position.

In a first sense, an electromechanical cable actuator assembly includes a motor having a first output shaft with a first gear mounted thereon, a gear assembly coupled to the first gear, a spring-loaded return assembly coupled to the gear assembly being configured to apply a force to the gear assembly to return the electromechanical cable assembly to a first position, and an electronic motor control circuit coupled to the motor. The electronic motor control circuit includes a drive circuit configured to drive the motor in a first direction against the force exerted by the spring assembly, and a braking circuit configured to slow the rate of return of the cable assembly to the first position.

In a second sense, a control circuit for an electromechanical cable actuator assembly having a motor, a gear assembly coupled to the motor and a spring-loaded return assembly coupled to the gear assembly being configured to apply a force to the gear assembly to return the electromechanical cable assembly to a first position includes a drive circuit configured to drive the motor in a first direction against the force exerted by the spring assembly, and one or more means for slowing the rate of return of the cable assembly to the first position.

In a third sense, a method for slowing the rate of return of an electromechanical cable actuator assembly having a motor, a gear assembly coupled to the motor and a spring-loaded return assembly coupled to the gear assembly being configured to apply a force to the gear assembly to return the electromechanical cable assembly to a first position includes limiting a voltage generated by the motor as the spring-loaded return assembly forces to the gear assembly to return the electromechanical cable assembly to the first position.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A better understanding of the electromechanical cable actuator assembly of the present invention may be had by reference to the drawing figures wherein:

FIG. 1 is a perspective view of an assembled electromechanical cable actuator assembly according to the present invention.

FIG. 2 is an exploded perspective view of the electromechanical cable actuator assembly shown in FIG. 1.

FIG. 3 is a side elevational view of the electromechanical cable actuator with the housing portions removed to illustrate the operation of the gear train.

FIG. 4 is a perspective view of the electromechanical cable actuator with portions 20 removed to illustrate the operation of the spring driven backdrive functions.

FIG. 5A is a flowchart of the logic embodied in the electronic control of the disclosed invention for 1 cycle per switch activation.

FIG. 5B is a flowchart similar to that shown in FIG. 5A for 2 cycles per switch activation.

FIG. 6 depicts a block diagram on an electronic control assembly and motor.

FIG. 7A depicts a first electronic braking circuit.

FIG. 7B depicts a second electronic braking circuit.

FIG. 7C depicts a third electronic braking circuit.

FIG. 7D depicts a fourth electronic braking circuit.

FIG. 7E depicts a fifth electronic braking circuit.

FIG. 7F depicts a sixth electronic braking circuit.

### DETAILED DESCRIPTION

The invention will now be described with reference to the drawing figures, in which like reference numerals refer to like parts throughout.

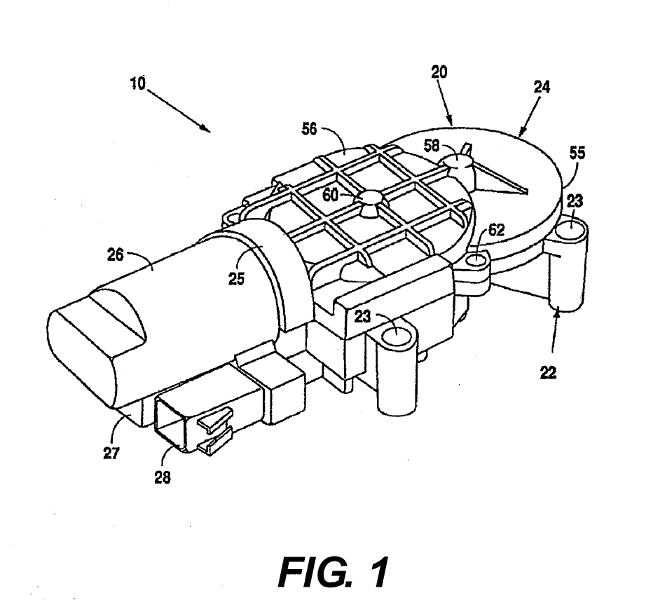

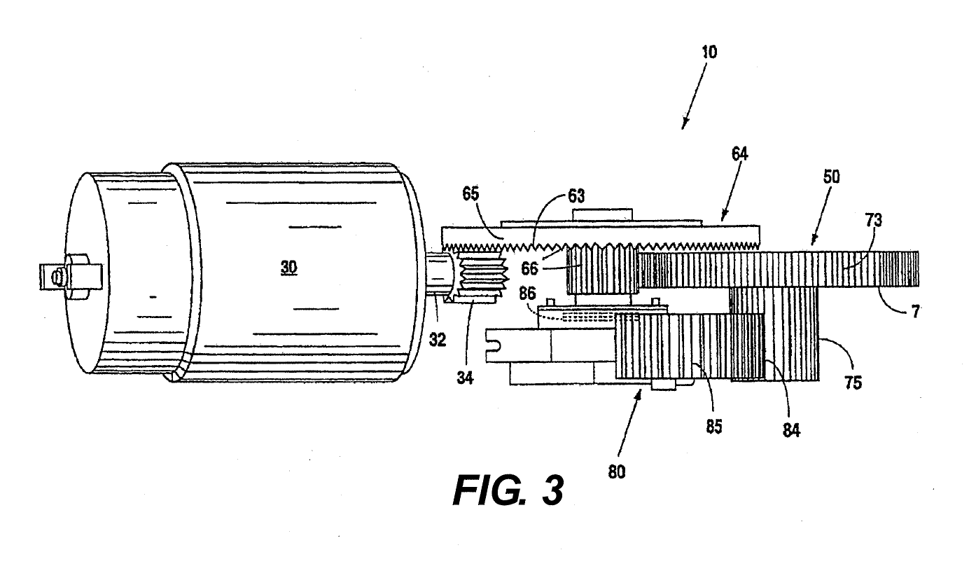

As will be seen in FIGS. 1, 2, 3, and 4, the electromechanical cable actuator 10 of the present invention is a self-contained device whose size is conducive to allowing its installation in a vehicle. To meet the requirements of automobile manufacturers, the disclosed electromechanical cable actuator 10 must be operable using the available electrical power provided by the electrical system typically found on a passenger vehicle. Specifically, the disclosed electromechanical actuator 10 must operate at a low voltage (specifically, 12 volts in most U.S. passenger vehicles) and have a small current draw (typically, 5 amps maximum). Yet, at the same time, the electromechanical actuator 10 must be able to impart a sufficient level of force on a cable to rapidly operate the mechanical locking portions of various different types of complex vehicle seating systems. Thus, when electrical power is supplied to the motor 30 through either the closing of a switch or by a remote device, the rotational force of the motor 30 will be quickly translated into a sufficient amount of linear force on a cable so that seating system (not shown) which is attached to the cable 44 will be unlocked from its locking system and thereby be allowed to properly fold, flip, or collapse. In addition to being small in size, the electromechanical cable actuator 10 must be easy to manufacture, low in cost, quiet in operation, simple to install, and readily connectable to the electrical system of a passenger vehicle.

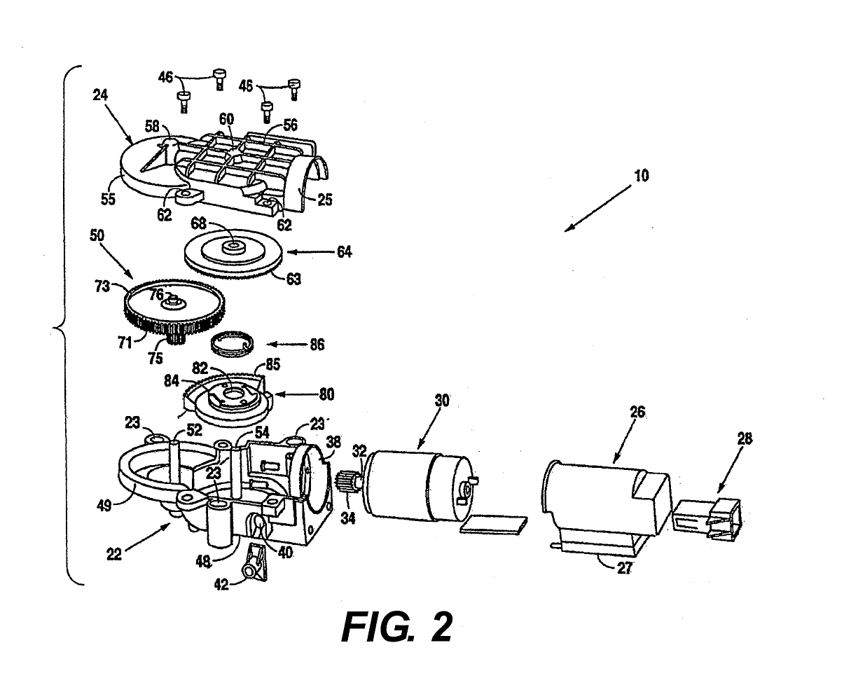

As will be seen in FIGS. 1 and 2, the disclosed electromechanical cable actuator 10 includes a housing assembly 20, which includes a lower housing assembly 22, an upper housing assembly 24, a housing 26 for the motor, and a power connection 28.

In the expanded view, FIG. 2, with the motor housing 26 moved away and the lower housing assembly 22 separated from the upper housing assembly 24, the construction of the electromechanical cable actuator 10 may be better understood by those of ordinary skill in the art.

As previously indicated, the motor 30 is used to drive the electromechanical cable actuator 10 of the present invention. The motor 30 is enclosed by a motor housing 26, which includes a portion 27 for the insertion of a circuit board to control the operation of the motor 30 and limit current draw. The output of the motor 30 is rotating output shaft 32. A small gear 34 is fitted to the output shaft 32. The small gear 34 turns with the output shaft 32.

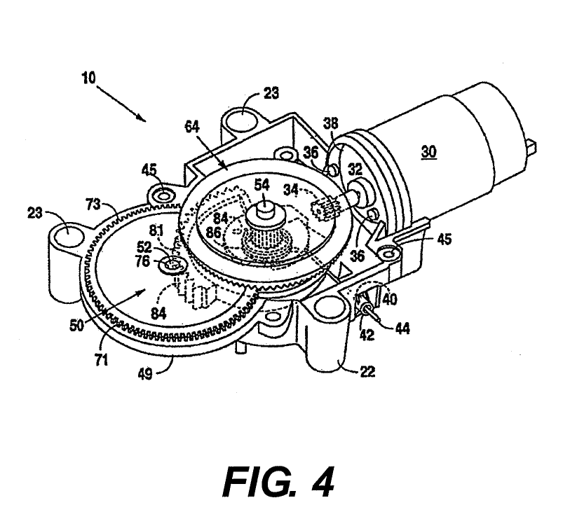

The motor assembly 30 is held in place by mounting screws 36 which pass through a motor mounting face 38 formed as part of the lower housing assembly 22. The lower housing assembly 22 includes multiple holes 23 on its perimeter through which mounting bolts may pass to affix the electromechanical cable actuator 10 of the present invention to a mounting point on a vehicle (not shown). Also, as may be seen in FIG. 4, located on the lower housing assembly 22 are a cable hole 40 and a cable guide 42. Cable hole 40 and cable guide 42 permit the cable 44 portion of the present invention to exit the electromechanical cable actuator 10. Also included on the lower housing 22 assembly are a plurality of small holes 45 through which fasteners 46 may be placed for attaching the lower housing assembly 22 to the upper housing assembly 24.

The portion of the lower housing assembly 22 closest to the motor 30 includes first a well 48 in which the rotatable pulley assembly 80 is mounted. The opposite end of the lower housing assembly 22 includes a second well 49 for the mounting of the intermediate spur gear assembly 50.

Extending upwardly from the bottom of the lower housing assembly 22 is a first shaft 52 on which the intermediate spur gear assembly portion 50 of the present invention is mounted. Also extending upwardly from the bottom of the lower housing assembly is a second shaft 54 on which the rotatable pulley assembly 80 and face gear and spur gear assembly 64 are mounted.

The upper housing assembly 24 includes an arcuate portion 25 which fits over the motor mounting face 38 on the lower housing assembly 22. At the distal end of the upper housing assembly is a flanged portion 55 which fits over the lower housing assembly 22. The flanged portion 55 encloses the intermediate spur gear assembly 50. Between the arcuate portion 25 and the flanged portion 55 is an intermediate portion 56. The intermediate portion 56 includes a first seat 58 for mounting the top of the first shaft 52 and a second seat 60 for mounting the top of the second shaft 54. Also included in the upper housing assembly 24 are a plurality of holes 62 through which fasteners 46 may pass to attach the upper housing assembly 24 to the lower housing assembly 22.

Positioned just under the upper housing assembly 24 is a face gear and spur gear assembly 64. The face gear and spur gear assembly 64 is turned by engagement of its teeth 63 with the small gear 34 affixed to the output shaft 32 of the motor 30. Because the face gear 65 and the spur gear 66 in the face gear and spur gear assembly 64 are made as one piece, when the face gear 65 turns, the spur gear 66 will also turn. The face gear and spur gear assembly 64 are mounted by engagement of the central hole 68 formed therein and the top portion of the second shaft 54.

Just beneath the face gear and spur gear assembly 64 is the intermediate spur gear assembly 50. The intermediate spur gear assembly 50 includes an upper large gear 71 whose teeth 73 engage the spur gear 66 of the face gear and spur gear assembly 64. Affixed to the underside of the intermediate spur gear assembly 50 is a small spur gear 75. Because the upper large spur gear 71 and the small lower spur gear 75 are formed as a single piece, when the large spur gear 71 turns, the lower spur gear 75 will also turn. Formed in the middle of the intermediate spur gear assembly is a hole 76 which enables the intermediate spur gear assembly 50 to be mounted on the first shaft 52.

Located under the intermediate spur gear assembly 50 is the rotatable pulley assembly 80. The rotatable pulley assembly 80 includes a central hole 82 so that it may be mounted on the first shaft 52. At the edge of the rotatable pulley assembly 80 is a spur gear section 84 which may be turned by engagement of its teeth 85 on the small spur gear 75 of the intermediate spur gear assembly 50.

Further included in the rotatable pulley assembly 80 is a spring return 86. The spring return 86 is depicted in FIG. 4. When the rotatable pulley assembly 80 is turned, energy is stored in a coil spying 86. The stored energy, when released from the coil spring 86, will restore the cable 44 to its original position.

In an alternate embodiment, the circuit board contained in the lower housing assembly 22 will include electronics which both limit the current draw and actuate the motor 30 for brief intervals when the energy in the spring 86 is released. The operation of the motor 30 for brief intervals both slows down and quiets the movement of the cable 44 to its start position.

Operation

The electromechanical cable actuator 10 of the present invention operates by first applying power to the motor assembly 30. The output shaft 32 of the motor assembly 30 is then caused to turn. Because a gear 34 is attached to the output shaft 32 of the motor assembly 30, the turning gear 34 which engages the teeth 63 of the face gear portion 65 of the face gear and spur gear assembly 64 will cause the face gear and spur gear assembly 64 to rotate. The engagement of the teeth 63 of the spur gear portion 66 of the face gear and spur gear assembly 64 with the teeth 73 of the large spur gear portion 71 of the intermediate spur gear assembly 50 will cause the small spur gear 75 to turn. This turning of the small spur gear 75 will cause the rotatable pulley assembly 80 to turn. Because the cable is affixed to the rotatable pulley assembly 80, the force on the cable 44 will cause it to move. This movement is of sufficient length and force to unlock a locking mechanism or provide the initiation of movement which will enable the seats in a vehicle to be properly positioned, as desired by the driver of the vehicle.

In the preferred embodiment of the invention, the cable travel was set to be approximately 34 mm. However, by modifying the various ratios and the size of the parts, it has been found that a cable travel of about 30 mm to about 55 mm falls within the capability of the disclosed invention.

In the preferred embodiment of the present invention, it has been found that a sufficient cable load to release commonly used latches is obtainable. By slight adjustments to the size of the various components, it will be understood by those of ordinary skill in the art that a force on the cable may range from about 350 newtons to about 600 newtons.

To assure that the electrical system of a passenger vehicle is not overloaded by the electromechanical cable actuator 10 of the present invention, it has been found that a motor 30 that provides a torque 140 N-mm to about 200 N-mm, whose current draw is about 5 amps in a 12-volt system, is preferable. To achieve the desired speed of cable operation, it has been found that a motor whose operating speed is from about 1,500 rpm to about 3,500 rpm is satisfactory. The time for the cable to travel through the predetermined travel length ranges from about 0.5 secs. to about 1.5 secs.

In the preferred embodiment, the drive train provides a gear ratio of about 109:1. It will be understood by those of ordinary skill in the art that the disclosed system will enable a speed reduction in the range of about 100:1 to 125:1.

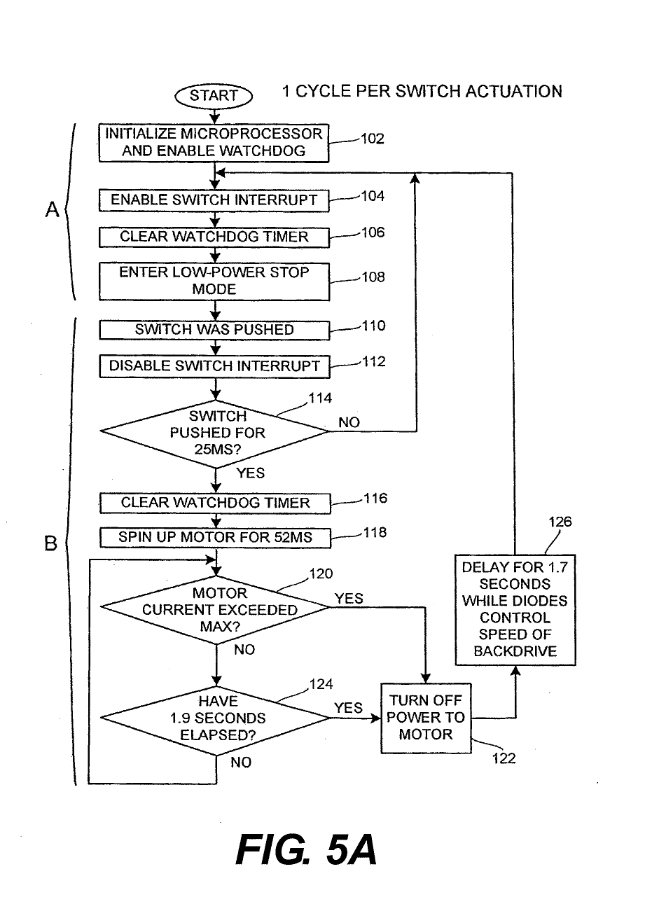

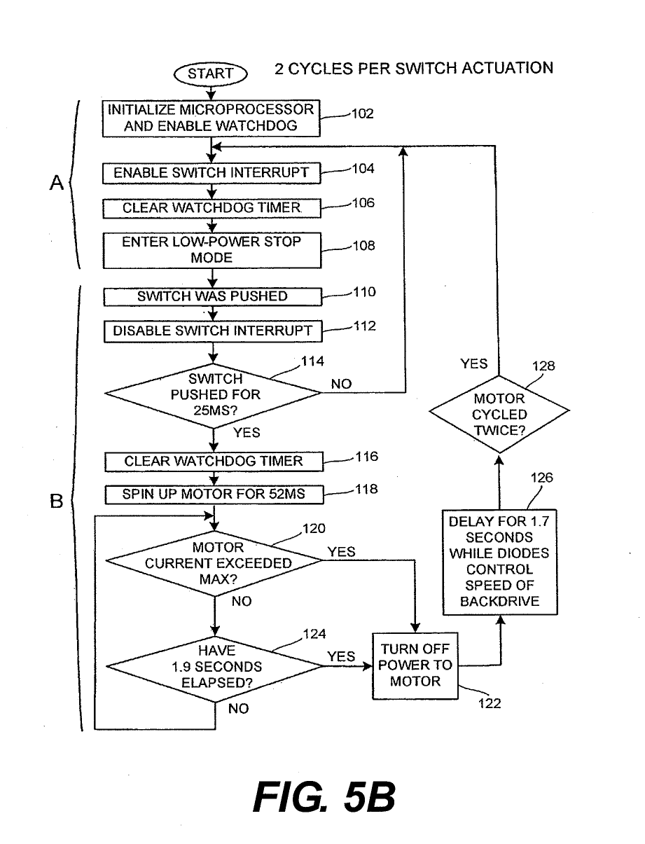

The operation of the system is controlled pursuant to the flowcharts at FIG. 5A and FIG. 5B. FIG. 5A demonstrates the operation of a single cycle of the system per activation of an activation switch. FIG. 5B is similar to FIG. 5A but shows two cycles of the system per activation of an activation switch.

As may be seen in FIG. 5A and FIG. 5B, both flowcharts include an initial group of steps A which set up the imbedded logic in the system before the activation of the activation switch is sensed. The steps in Group A begin with an initialization and watchdog enablement step 102. Once completed, the switch interrupt function is enabled 104 and the watchdog time is cleared 106. To conserve energy, system is then directed into a low power mode 108.

The activation 110 of the activation switch begins those steps designated as Group B. This triggers disabling the switch interrupt function 112. If the activation switch was only activated for a short period of time, as could happen if the switch were inadvertently bumped, the logic step 114 returns the system to step 104. If the designated period of time is exceeded, in the preferred embodiment 25 ms, the watchdog timer is cleared 116 and the motor 30 is activated 118 for a designated period of time. A current limit step 118 assures that the maximum designated current draw has not been exceeded. If an excess current draw is sensed, the motor 30 is turned off in step 122. If the current draw is not exceeded, the time of operation of the motor 30 is measured and compared with a preset time in step 124. If the motor is turned off, there is a built-in delay 126 where the speed of the backdrive is controlled.

In the backdrive situation, energy stored in the return spring 86 causes the motor 30 to turn. The rotational force of the spring 86 therefore causes the motor 30 to act like a generator and produce electrical energy. Bi-directional diodes are used to limit the voltage that motor 30 can produce when acting as a generator. The interruption of motor operation and the use of the bidirectional diodes facilitate return of the cable 44 to its starting position at a near-constant rate and a significant reduction in the operating noise of the electromechanical actuator 10.

In FIG. 5B, those of ordinary skill in the art will notice that an additional step 128 has been added which determines whether or not the motor 30 has cycled twice. If the motor 30 has cycled only once, then the motor 30 is caused to cycle again. If the motor 30 has cycled twice, then the logic flow goes to the top of the flowchart.

There is thereby provided by the present invention an electromechanical cable actuator which is suitable for use in a passenger vehicle. The disclosed electromechanical cable actuator will provide the necessary forces and operate with the necessary speed and reliability to perform a large variety of functions in vehicles in addition to simply operating complex seating system mechanisms.

The Electronic Control Circuitry

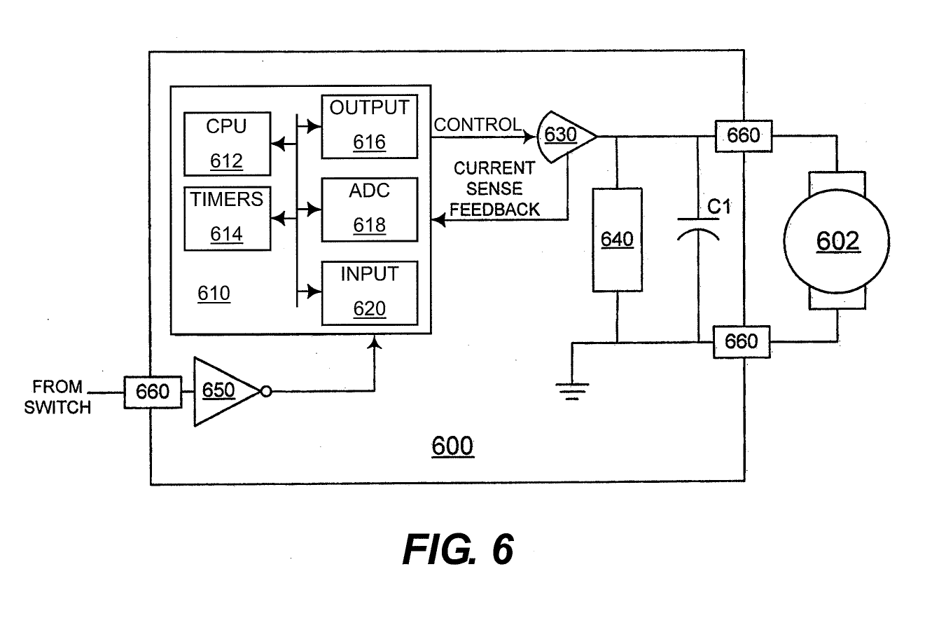

FIG. 6 depicts a block diagram on an electronic control assembly 600 and motor 602. As shown in FIG. 6, the electronic control assembly 600 includes a controller 610, an electronic motor driver 630 suitable for driving the motor 602 and having an integral current sensor (not shown), a braking circuit 640 in parallel with capacitor C1 (used to reduce electromagnetic noise), terminals 660 and buffer 650. The controller 610 includes a central processing unit (CPU) 612 having a memory (not shown), a digital output 616 leading to the motor driver 630, an analog-to-digital converter (ADC) 618 receiving a current sense feedback signal from the motor driver 630 and an input 620 for receiving a buffered switch signal provided by buffer 650 and a number of timers 614.

Although the exemplary controller 610 of FIG. 6 uses a bussed architecture, it should be appreciated that any other architecture, such as discrete electronic circuit designs, state machines, programmable logic (e.g., FPGAs) and so on, may be used as is well known to those of ordinary skill in the art.

In operation, the controller 610 can first initialize various portions of its peripherals 614-620 in order to perform various input/output operations and timing operations, e.g., watchdog timer operations, described above.

Upon receiving a switch control signal via a terminal 660 and buffer 650, the controller 610 can then activate motor driver 630 according to the proscribed times, sequences and conditions discussed above with variances to be expected from embodiment to embodiment. For example, in operation the controller 610 can activate the motor driver 630 for up to a few seconds, or cut driver operation early if the current sense feedback signal from driver 630 (which provides an indication of the output current of the driver 630) indicates the motor is consuming an excessive current indicative that the motor reached a mechanical stop, stalled or otherwise malfunctioned.

As the actuator assembly associated with motor 602 is later forced back to its initial position, the motor 602 will tend to act like a generator. Consistent with most motors/generators, the motor 602 will tend to produce a voltage across its terminals as a function of motor speed and/or tend to provide an available current as a function of the torque/force acting upon the motor 602. Accordingly, it can be appreciated that motor speed may be manipulated more directly by using a voltage control approach, or motor speed may be manipulated less directly via a force/torque control approach by controlling current absorption of motor current.

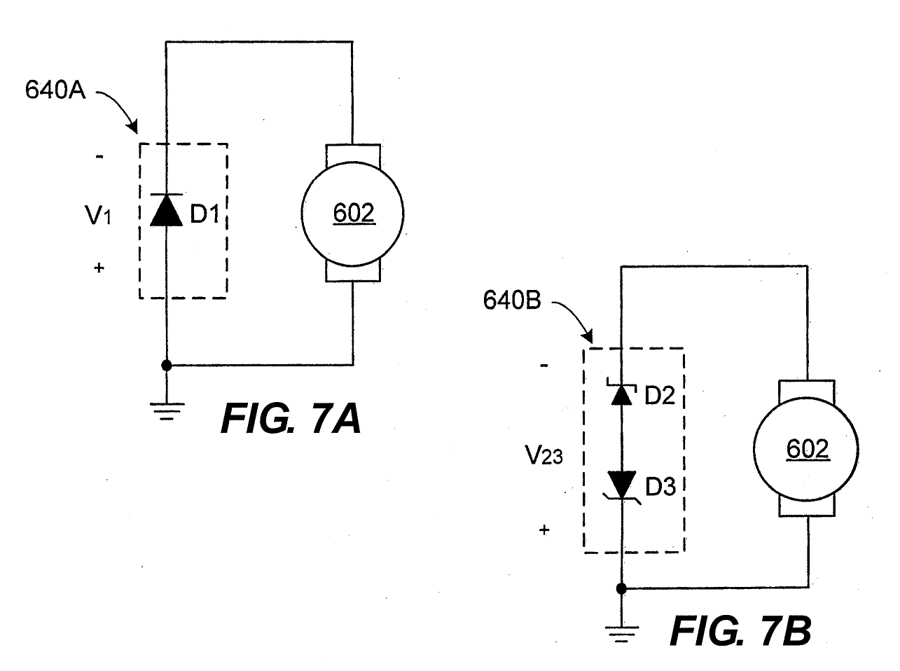

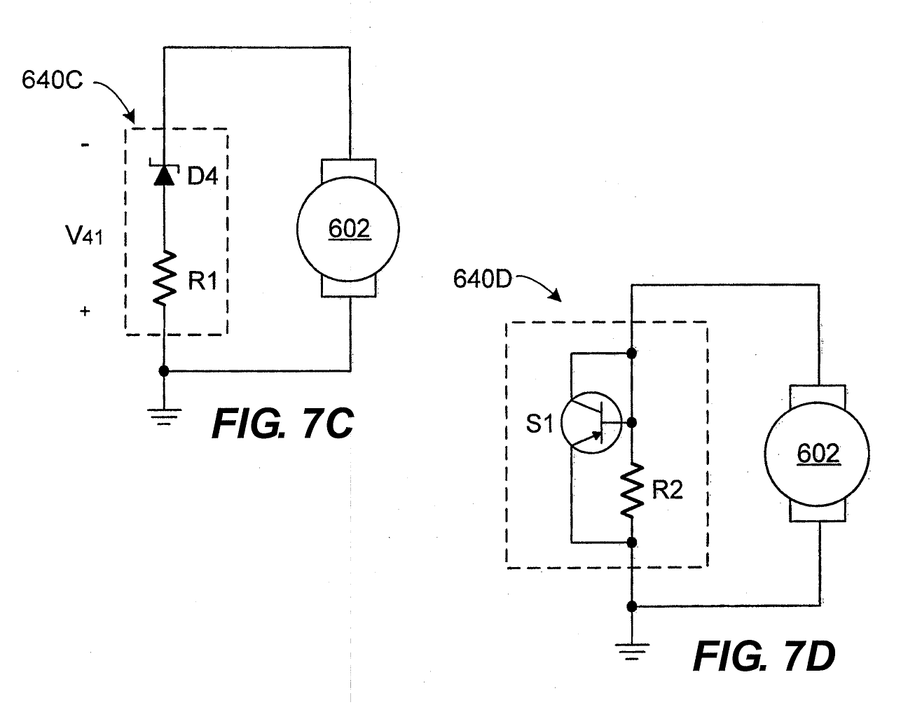

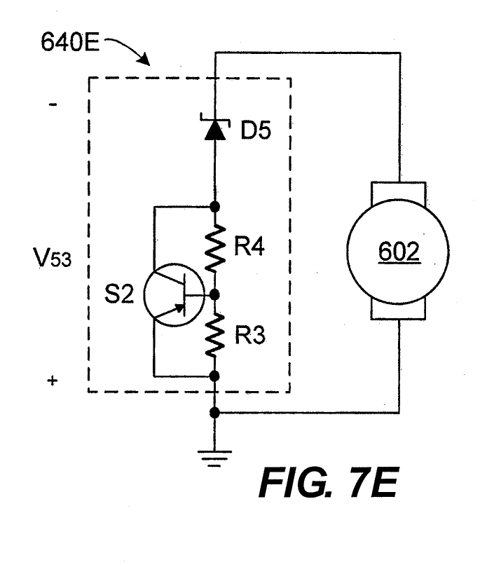

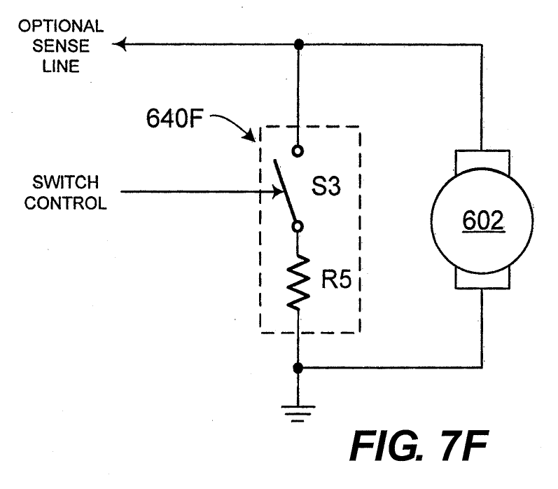

FIG. 7A depicts a first braking circuit 640A in conjunction with motor 602. As shown in FIG. 7A, the first braking circuit 640A consists of a single silicon diode D1 having a voltage drop of about 0.7V to 0.9V. While a silicon diode is used in the present embodiment, a variety of other diodes, such as Shottkey diodes, germanium diodes and so on, alternatively can be used. Further, more than one diode may be placed in series to increase the voltage drop with each diode being all the same type or a mixture of types. Returning to FIG. 7A, as diode D1 will generally limit the voltage across motor to diode voltage V₁, the braking circuit 640A of FIG. 7A can be considered a voltage control approach.

FIG. 7B depicts a second braking circuit 640B in conjunction with motor 602. As shown in FIG. 7B, the second braking circuit 640B includes a Shotkey diode D2 in series with a Zener diode D3. As Zener diodes can be crafted to have reverse-bias breakdown voltages ranging from a few volts to tens of volts, the second braking circuit 640B can allow for a wide variety of controlled speeds with a selection of diode. For example, by using a Zener diode having a 3.6V breakdown voltage, reverse voltage V₂₃ can be limited to about 4 volts. Similarly, by using a Zener diode having a 4.6V breakdown voltage, reverse voltage V₂₃ can be limited to about 5 volts.

FIG. 7C depicts a third braking circuit 640C similar to that of FIG. 7B but having a resistor R1 substituted for Zener diode D3. While the present braking circuit 640C may not be able to control voltage so precisely as the previously shown braking circuits (and tends to appear a bit more of a torque control device), braking circuit 640C may provide a marginally less expensive circuit as compared to the circuitry of FIG. 7B.

FIG. 7D depicts a fourth braking circuit 640D similar to that of FIG. 7A but employing a transistor S1 and resistor R1 in lieu of a diode. While the present braking circuit 640D might be expected to be more expensive than the braking circuit 640A of FIG. 7A, braking circuit 640D nonetheless provides a viable and useful alternative embodiment.

FIG. 7E depicts a fifth braking circuit 640E similar to that of FIG. 7B but employing a transistor S2 and resistors R2 and R3 in lieu of Zener diode D3. Again while the present braking circuit 640E might be expected to be more expensive than the braking circuit 640B of FIG. 7B, braking circuit 640E nonetheless provides a viable and useful alternative embodiment.

FIG. 7F depicts a sixth braking circuit 640F utilizing a controllable switch S3 in series with an optional resistor R5. By sensing the voltage across the motor 602 or current through R5, and modulating the switch S3 using a controller of some form, braking circuit 640F can be used to control the voltage across motor 602, control current (and thus torque) or control some combination thereof. However, it might be appreciated that the sixth braking circuit 640F might also operate without any sensing, i.e., by simply engaging switch S1 (either fully on or using a pulse width modulation (PWM) approach) whenever braking is desired and presumably when the motor is not being driven.

As a further embodiment of note, it should be appreciated that, instead of using a braking circuit, such as any of those shown in FIGS. 7A-7F, to slow the rate of actuator return, the controller 610 can provide a braking function by applying a partial drive signal to the motor, such as a pulse width modulated (PWM) signal having a duty cycle sufficient to slow, but not stop, the motor 602. such a scheme may either wholly replace an independent braking circuit or be used as a means of supplementing am independent braking circuit. Of course, such drive signal might be expected to require more energy than the braking approaches discussed above, but may reduce component count as a benefit.

Conclusion

While the disclosed invention has been described in terms of its preferred and alternate embodiments, those of ordinary skill in the art will understand that numerous other embodiments of the present invention may become apparent while reading of the foregoing disclosure. Such other embodiments shall be included within the scope and meaning of the appended claims.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An electromechanical cable actuator assembly, comprising:
a motor having a first output shaft with a first gear mounted thereon;
a gear assembly coupled to the first gear;
a spring-loaded return assembly coupled to the gear assembly being configured to apply a force to the gear assembly to return the electromechanical cable assembly to a first position; and
an electronic motor control circuit coupled to the motor, the electronic motor control circuit including,
a drive circuit configured to drive the motor in a first direction against the force exerted by the spring assembly, and
a braking integrated into the drive circuit configured to slow the rate of return of the cable assembly to the first position by providing a reduced drive signal to the motor.

2. The electromechanical cable actuator assembly of claim 1, wherein the reduced drive signal is a pulse width modulated signal.

3. The electromechanical cable actuator assembly of claim 1, wherein the reduced drive signal is a reduced voltage pulse width modulated signal.

4. The electromechanical cable actuator assembly of claim 1, wherein the reduced drive signal is a reduced current pulse width modulated signal.

5. A control circuit for an electromechanical cable actuator assembly having a motor, a gear assembly coupled to the motor and a spring-loaded return assembly coupled to the gear assembly being configured to apply a force to the gear assembly to return the electromechanical cable assembly to a first position; the control circuit comprising:
a drive circuit configured to drive the motor in a first direction against the force exerted by the spring assembly, and
one or more means for slowing the rate of return of the cable assembly to the first position.

6. The control circuit of claim 5, wherein the means for slowing includes a voltage limiting means for limiting the maximum voltage generated across the motor.

7. The control circuit of claim 6, wherein the means for slowing includes two diodes connected in series.

8. The control circuit of claim 6, wherein the means for slowing includes a transistor-based voltage limiter.

9. The control circuit of claim 5, wherein the means for slowing includes a controllable-switch-based voltage limiter.

10. The control circuit of claim 5, wherein the means for slowing includes a controllable-switch-based current limiter.

11. The control circuit of claim 5, wherein the means for slowing includes a means for pulse width modulating the drive circuit.

12. A method for slowing the rate of return of an electromechanical cable actuator assembly having a motor, a gear assembly coupled to the motor and a spring-loaded return assembly coupled to the gear assembly being configured to apply a force to the gear assembly to return the electromechanical cable assembly to a first position; the method comprising:
limiting a voltage generated by the motor as the spring-loaded return assembly forces to the gear assembly to return the electromechanical cable assembly to the first position.

13. The control circuit of claim 12, wherein the step of limiting is accomplished passively.

14. The control circuit of claim 12, wherein the step of limiting limits the current generated by the motor as the spring-loaded return assembly forces to the gear assembly to return the electromechanical cable assembly to the first position.

15. The control circuit of claim 12, wherein said gear assembly coupled to the motor has a gear ratio reduction in the range of 100:1 to 125:1.
